(19) United States
(12) Patent Application Publication
(10) Pub. No.: US 2014/0361992 A1
(43) Pub. Date: Dec. 11, 2014

(54) Method and apparatus for inputting data packets into an electronic device

(71) Applicant: Shane Chen, Camas, WA (US)

(72) Inventor: Shane Chen, Camas, WA (US)

(21) Appl. No.: 13/912,189

(22) Filed: Jun. 6, 2013

(51) Int. Cl. G06F 3/023

(52) U.S. Cl. CPC G06F 3/0233
USPC 345/169

(57) ABSTRACT

A condensed keyboard for mobile phones and other small electronic devices, having two sets of four character keys arrayed on the back of the device for the user's fingers, and one or two joysticks or similar radially movable components for one or both of the user's thumbs. The position of the joystick when a key is pressed determines which of a set of different characters associated with that key is inputted. The joysticks can also be used to input direction commands, for video games and other purposes.

### FIELD OF THE INVENTION

The present invention relates generally to the field of input apparatuses for electronic devices, and particularly to condensed keyboards. It also relates to control apparatuses for games, particularly for small electronic devices.

### BACKGROUND OF THE INVENTION

Typing on mobile phones and other small electronic devices has always been relatively slow and inconvenient compared to full-sized keyboards. Recent improvements in both on-screen and hardware keyboards have significantly increased the ease and speed of typing, but still the most widespread methods are designed to engage only one or two of the user's fingers. A character inputting system that makes use of all of the user's fingers would be more efficient. It is also the case that many users tend to produce fewer typographical errors on hardware keyboards than on on-screen keyboards; however, mobile phones without hardware keyboards have become much more common, due in part to lack of space for physical keys as screen sizes increase.

The prior art includes numerous hardware keyboards which are condensed so as not to require a separate key for each character. The reduced numbers of keys allow the keyboards to fit on the back surfaces and/or the sides of small electronic devices. Since it may be tedious for users to learn a new typing system (as is necessary with chordal condensed keyboards), it is advantageous to employ a key-to-character mapping scheme that simulates the experience of typing on a conventional keyboard. One example is U.S. Pat. No. 8,130,199, in which a set of character keys represents a “home row” and a second set of control buttons shifts to the upper or lower row when pressed in combination with the character keys. However, there is room for an alternative having smoother row shifting than the keyboard of '199.

### SUMMARY OF THE INVENTION

It is therefore a goal of the present invention to provide a character input apparatus that can be used more efficiently than the prior art. In one aspect of the present invention, a character input apparatus has eight keys on the back of an electronic device, each of the keys being capable of inputting a plurality of characters. A radially movable selection member (such as a joystick) on or near the top edge of the device can be manipulated by the user's thumb. The position of the selecting member at the time a key is pressed determines which of the characters associated with the key is inputted. Other embodiments may have two selection members, one for each thumb.

The selection member(s) can also be used to input direction commands, which can apply to scrolling, switching between interactive elements on the screen, and controlling video games.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 shows a rear view of one embodiment of the input apparatus of the present invention on an electronic device.

FIG. 2 shows a front view of the input apparatus and electronic device of FIG. 1.

FIG. 3 shows one possible key-to-character mapping.

### DETAILED DESCRIPTION

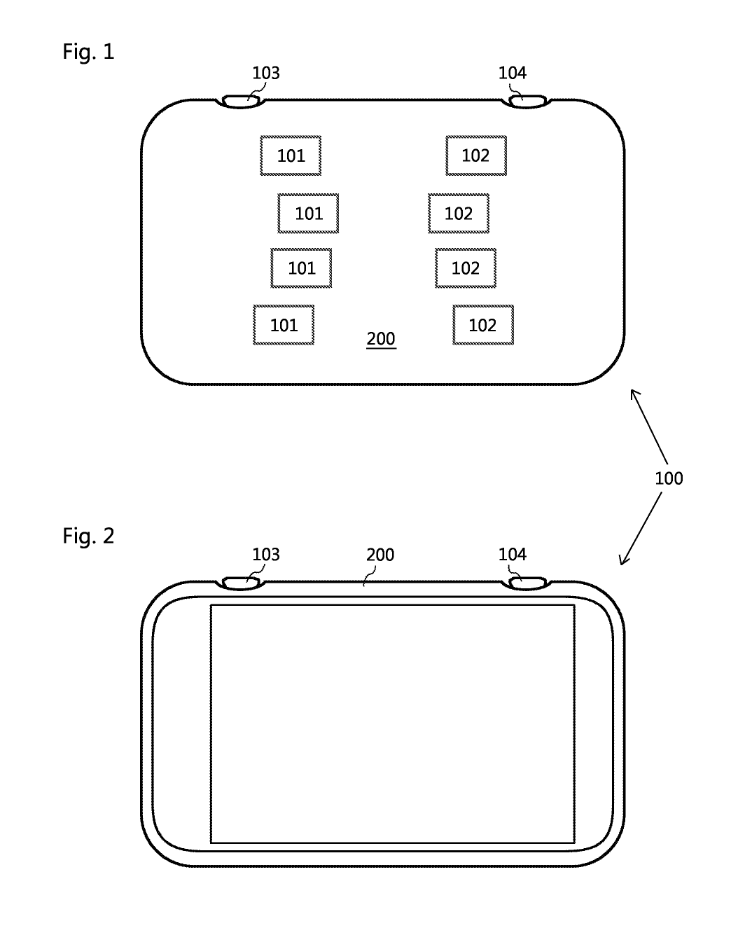

In FIG. 1, one embodiment of the input apparatus of the present invention is shown coupled to an electronic device 100. FIG. 2 shows a front view of the same. The apparatus comprises a set of eight keys 101, 102 on the back surface of a cover 200 coupled to device 100. In this embodiment the apparatus further comprises a right and a left thumb-controlled radially movable selection member 103, 104 at or near the top edge of device 110. Keys 101, 102 are arranged in two groups and positioned such that, when device 100 is held between the user's hands, four keys 102 can be accessible to the fingers of the left hand and four keys 101 can be accessible to the fingers of the right hand. Selection members 103, 104 are continuously movable in two axes.

Each of keys 101, 102 is capable of inputting a plurality of characters, while selection members 103, 104 are used to shift between the available characters for keys 101, 102. Right and left selection members 103 and 104 may exclusively control right and left keys 101 and 102 respectively, or both selection members 103, 104 may control all keys 101, 102. When a key 101, 102 is pressed, the current position of selection members 103, 104 determines which of the characters available to that key is inputted.

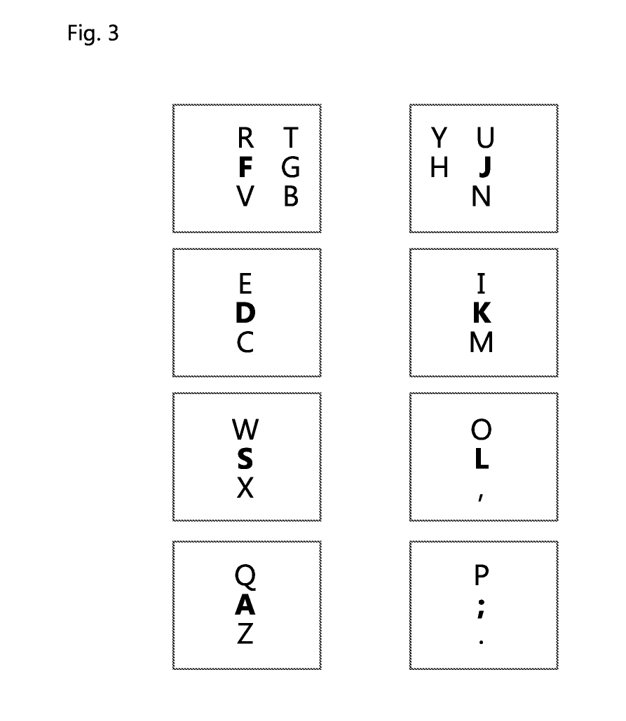

FIG. 3 shows an example of a QWERTY character mapping scheme in which the character keys represent the “home row” and the selection member is used to shift to the upper or lower rows, and to shift to the middle set of characters.

Other embodiments may have additional function keys which can be pressed individually or in combination with keys 101, 102 to produce numbers or less commonly used characters, among other possible functions.

Selection members 103, 104 may also be used as to input direction commands when not being used for typing. For instance, selection members 103, 104 can be used to switch between interactive components on the screen of device 100, or for scrolling. Selection members 103, 104 can also be used to input direction commands in video games, with keys 101, 102 performing various other functions within the game.

The embodiment described above and shown in the figures has two selection members 103 and 104, but other embodiments may have a single selection member. Also, the embodiment shown and described is part of a cover 200 for device 100, but in other embodiments the input apparatus may be built into the device itself, or may be an attachable accessory other than a case or cover.

1. An apparatus for inputting data packets into an electronic device, comprising:
a plurality of keys arranged such that some of said keys are accessible to the fingers of the user's left hand and some of said keys are accessible to the fingers of the user's right hand, each of said keys being capable of inputting a plurality of different data packets; and
at least one selection member, continuously movable in two axes and accessible to at least one of the user's thumbs;
wherein which of the data packets associated with a key is inputted when one of said keys is pressed depends on the current position of said at least one selection member.

2. The apparatus of claim 1, wherein:
said keys are on the surface of said device which faces away from the user during use;
and said at least one selection member is on or near the top edge of said device.

3. The apparatus of claim 1, comprising a single selection member, positioned so as to be accessible to one of the user's thumbs.

4. The apparatus of claim 1, comprising two selection members, one accessible to the user's left thumb and the other accessible to the user's right thumb.

5. The apparatus of claim 1, further comprising at least one function button which can be pressed alone or in conjunction with said keys in order to input data packets not otherwise available to said keys.

6. The apparatus of claim 1, wherein said apparatus is built into said electronic device.

7. The apparatus of claim 1, wherein said apparatus is a separate accessory which can be attached to said device.

8. The apparatus of claim 7, wherein said apparatus is part of a case or cover for said device.

9. The apparatus of claim 1, wherein said at least one selection member can also be used to input direction commands.

10. A method for inputting data packets into an electronic device, comprising:
using one's thumb or thumbs to manipulate a selection member movable in two axes; and
pressing one of a plurality of keys, some of said keys being accessible to the fingers of the left and some of said keys being accessible to the fingers of the right hand;
wherein the position of said selection member at the time said key is pressed determines which of said data packets available to said key is inputted;
whereby a greater number of unique data packets can be inputted than the number of said keys.
